(19) United States
(12) Patent Application Publication
(10) Pub. No.: US 2010/0075161 A1
(43) Pub. Date: Mar. 25, 2010

(54) Pigment Composition

(75) Inventors: Erik Lindgren, Bohus (SE); Kjell Rune Andersson, Goteborg (SE); Olof Ericksson, Goteborg (SE); Yiva Wildlock, Kungalv (SE)

Correspondence Address: AKZO NOBEL INC., LEGAL & IP, 120 WHITE PLAINS ROAD, SUITE 300, TARRYTOWN, NY, 10591, US

(73) Assignee: AKZO NOBEL N.V., Arnhem (NL)

(21) Appl. No.: 12/528,392

(22) PCT Filed: Jan. 25, 2008
(86) PCT No.: PCT/SE2008/050088

§ 371 Date: Aug. 24, 2009

Related U.S. Application Data
(60) Provisional application No. 60/903,458, filed on Feb. 26, 2007.

(30) Foreign Application Priority Data
Feb. 26, 2007 (EP) 07103075.3
Jul. 20, 2007 (EP) 07112874.8

(51) Int. Cl. B32B 9/06; C09B 67/22

(52) U.S. Cl. 428/452; 106/491; 106/465; 524/377

(57) ABSTRACT

The invention relates to an aqueous pigment composition comprising polyalkylene glycol and inorganic pigment particle comprising colloidal silica or silicate based particles or aggregates thereof, wherein polyalkylene glycol constitutes from 50 to 100 wt % of the total amount of organic material in the composition and the weight ratio of colloidal silica 5 or silicate based particles or aggregates thereof to organic material in the composition is from 1:3 to 30:1. The invention further relates to a process for its production, use thereof, a process for coating paper or paper board and coated paper or paper board.

The present invention relates to a pigment composition and a process for its production, use thereof, a process for coating paper or paper board and coated paper or paper board.

The development of ink jet printers has led to a demand for paper that is suitable for that purpose. Particularly, there is a demand for paper that is simple to produce but still enables ink jet printing of high quality.

It has been disclosed to use various kinds of coatings to produce paper suitable for ink jet printing. Examples of such coatings are disclosed in US Patent Application Publications 2002/0039639, 2002/0164464, 2003/0099816, 2003/0224129, 2004/0255820 and 2005/0106317, in U.S. Pat. Nos. 4,554,181, 5,55,1975, 6,472,013 and 6,797,347, and in WO 03/011981, WO 01/53107, WO 01/45956, EP 947349, EP 1120281, EP 1106373 and EP 1580019. Other examples include U.S. Pat. Nos. 6,416,626, 5,352,503 and 6,110,601 disclosing coating compositions comprising silica, polyethylene glycol and an organic binder such as starch or polyvinyl alcohol.

A new generation of coating compositions based on silica or silicate are disclosed in WO 2006/049545, WO 2006/049546 and WO 2006/049547.

WO 2006/049545 discloses a coating composition comprising colloidal silica or aluminosilicate in combination with extender particles.

WO 2006/049546 discloses a coating composition comprising silica or aluminosilicate in combination with a water soluble aluminium salt or a cationic polymer.

WO 2006/049547 discloses a coating composition comprising colloidal silica or aluminosilicate in combination with a water soluble aluminium salt or a cationic polymer that can be used without any organic coating binder.

It is an object of the invention to provide a pigment composition suitable for coating paper or paper board for ink jet printing and that is simple to produce with high dry content.

It is another object of the invention to provide a coating formulation that is simple to apply on the surface of paper or paper board to make it suitable for ink jet printing.

It is still another object of the invention to provide a paper or paper board suitable for ink jet printing that is simple to produce.

It has been found that the objects can be achieved by a novel pigment composition. Thus, one aspect of the invention concerns an aqueous pigment composition, preferably in the form of an aqueous dispersion, comprising polyalkylene glycol and inorganic pigment particles comprising colloidal silica or silicate based particles or aggregates thereof, wherein polyalkylene glycol constitutes from 50 to 100 wt %, preferably from 60 to 100 wt % or from 70 to 100 wt % of the total amount of organic material in the composition and the weight ratio of colloidal silica or silicate based particles or aggregates thereof to organic material in the composition is from 1:3 to 30:1, preferably from 1:1 to 20:1 or from 1.5:1 to 10:1.

It has been found that the presence of polyalkylene glycol enables high concentration of inorganic pigment particles, rendering it possible to apply high amounts of pigment particles on paper or paperboard in a single coating operation. Further, excellent results can be obtained by coating paper or paperboard with a pigment composition comprising no or only low amounts of other organic materials, particularly organic coating binders. It is thus preferred that the pigment composition is substantially free from or comprises, based on the total amount of pigment particles, less than 20 wt %, preferably less than 10 wt %, most preferably less than 3 wt % or less than 1 wt % of organic coating binders. Examples of such organic coating binders include polyvinyl alcohols, optionally modified starches, gums, protein binders (e.g. caseins and soy protein binders), latices (e.g. based on styrene butadien, acrylates, vinyl acetate, co-polymers of ethylene and vinyl acetates, styrene acrylic esters etc.) and mixtures thereof.

The term polyalkylene glycol as used herein refers to polymers of alkylene oxide preferably being substantially free from other co-polymerised monomers. Preferred polyalkylene glycols are substantially free from substituents. The amount of polyalkylene glycol in the composition is preferably from about 1 to about 50 wt %, most preferably from about 3 to about 25 wt %. Useful polyalkylene glycols include polyethylene glycol (PEG), polypropylene glycol and mixtures thereof, of which polyethylene glycol is particularly preferred. The average molecular weight M_{w} of the polyalkylene glycol is preferably from about 1000 to about 100000, most preferably from about 5000 to about 75000.

The inorganic pigment particles comprise colloidal silica or silicate based particles that preferably are synthetic and amorphous. The combination of comparatively high amounts of colloidal silica or silicate based particles with polyalkylene glycol has been found to give excellent printing properties of coated paper.

The pigment particles, at least those of colloidal silica or silicate based particles or aggregates thereof, preferably have a mean diameter from about 0.005 μm to about 25 μm, more preferably from about 0.007 μm to about 15 μm, most preferably from about 0.01 μm to about 10 μm. These particles preferably have a surface area from about 30 m²/g to about 600 m²/g, more preferably from about 30 to about 450 m²/g, most preferably from about 40 m²/g to about 400 m²/g or from about 50 m²/g to about 300 m²/g. The net surface charge of the pigment particles in the composition is preferably positive, in which case the dispersion is regarded as predominantly cationic.

The term diameter as used herein refers to the equivalent spherical diameter.

In an embodiment the colloidal particles comprise silica based particles, preferably in the form of an aqueous silica sol. In another embodiment the colloidal particles comprise silicate based particles, such as aluminosilicate or borosilicate, preferably in the form of an aqueous sol. Examples of colloidal borosilicate particles and their preparation include those described in e.g. WO 99/16708. Mixtures of various kinds of colloidal silica based and silicate based particles, or aggregates thereof, may also be used.

Preferably the compositions comprises, as a source of colloidal silica or silicate based particles or aggregates thereof, an aqueous sol of colloidal, optionally aggregated, primary silica or silicate based particles. The surface area of the primary particles is preferably from about 30 m²/g to about 600 m²/g, more preferably from about 30 to about 450 m²/g, most preferably from about 40 m²/g to about 400 m²/g or from about 50 m²/g to about 300 m²/g. The dry content of the aqueous sol of primary particles is preferably from about 0.5 wt % to about 70 wt %, most preferably from about 1 wt % to about 60 wt %.

Colloidal silica or silicate based primary particles have preferably been formed from an aqueous solution of alkali metal silicate where alkali metal ions are removed through an ion exchange process or where the pH of the alkali metal silicate solution has been reduced by the addition of an acid. A process based on ion exchange follows the basic principles described in R. K. Iler, “The Chemistry of Silica” 1979, pages 333-334 and results in an aqueous sol comprising colloidal negatively or positively charged particles of silica or silicate based particles. A process based on pH-reduction of alkali metal silicate follows the basic principles described in e.g. U.S. Pat. Nos. 5,176,891, 5,648,055, 5,853,616, 5,482,693, 6,060,523 and 6,274,112.

The sol may comprise colloidal primary particles of silica that may or may not be core or surface modified, for example with a metal oxide or other metal salt such as oxide or other salt of aluminium, titanium, chromium, zirconium, boron or any other suitable metal.

Suitable aqueous sols of colloidal primary silica or silicate based particles are commercially available, for example under the trademarks Ludox™, Snowtex™, Bindzil®, Nyacol™, Vinnsil™ or Fennosil™.

Unlike a sol formed by dispersing a powder of e.g. precipitated silica, gel-type silica or fumed silica, the colloidal particles in a sol prepared from alkali metal silicate by ion exchange or pH-reduction have never been dried to a powder, such as in the case for e.g. precipitated silica or gel-type silica.

It has been found that sols prepared from alkali metal silicate by ion exchange or pH-reduction, and particularly those having comparatively low surface area, give such a good adherence of the pigment particles to the paper or paperboard that the use of organic coating binders can be dispensed with.

In case the pigment particles in the composition comprise aggregates of colloidal primary particles, the mean particle diameter of these primary particles is preferably from about 5 nm to about 125 nm, most preferably from about 7 nm to about 100 nm. The colloidal primary particles are preferably in the form of an aqueous sol as described above.

Aggregation of primary particles in a sol to form a dispersion of porous aggregates may be performed with any suitable method, such as those described in R. K. Iler, “The Chemistry of Silica” 1979, pages 364-407. The degree of aggregation can be followed by measuring the viscosity and applying the Einstein and Mooney equations (see e.g. R. K. Iler, “The Chemistry of Silica” 1979, pages 360-364). The aggregation may be performed as a separate step or in a mixture also comprising other pigment particles.

In one embodiment, an anionic sol (comprising negatively charged colloidal primary particles) and a cationic sol (comprising positively charged colloidal primary particles) are mixed, resulting in the formation of porous aggregates of primary particles from both the sols.

In another embodiment a salt, preferably selected from divalent, multivalent or complex salts, is added to an anionic or cationic sol also resulting in the formation of porous aggregates. Examples of salts are aluminium chloride, poly aluminium chloride, poly aluminium silicate sulfate, aluminium sulfate, zirconium carbonates, zirconium acetates, alkali metal borates, and mixtures thereof.

In still another embodiment a bridging substance is used to form the aggregates from the primary particles. Examples of suitable bridging substances are synthetic and natural polyelectrolytes such as CMC (carboxymethyl cellulose), PAM (polyacrylamides), polyDADMAC (poly diallyl dimethyl ammoniumchloride), polyallyl amines, polyamines, starch, guar gums, and mixtures thereof.

Any combination including one, two or all three of the above aggregation methods can also be employed.

Each porous aggregate is formed from at least three primary particles, which inherently gives at least some pores. The mean particle diameter of the aggregates is preferably from about 0.03 to about 25 μm, more preferably from about 0.05 to about 10 μm, most preferably from about 0.1 μm to about 5 μm. It is to be understood that the average diameter of the porous aggregates is always larger than the average diameter of the primary particles they are formed from. The surface area of the aggregates is usually essentially the same as of the primary particles.

The inorganic pigment particles may additionally comprise particles of one or more of other inorganic materials such as particles of kaolinites, smectites, talcites, calcium carbonate minerals, precipitated calcium carbonate, precipitated silica, gel-type silica, fumed silica, and mixtures thereof. Preferably, the inorganic pigment particles comprise a combination of colloidal silica or silicate based particles as earlier described and other inorganic particles as mentioned above. The content of colloidal silica or silicate based particles particles, preferably in a sol prepared from alkali metal silicate by ion exchange or pH-reduction, is preferably from about 10 to 100 wt %, most preferably from about 30 to 100 wt % or from about 50 to 100 wt % of the total amount of dry pigment particles.

Precipitated silica refers to silica formed when ultimate silica particles in an aqueous medium are coagulated as loose aggregates, recovered, washed, and dried. Precipitated silica is commercially available, for example under the trademark Tixosil™.

Gel-type silica refers to particles formed from a silica gel (usually described as a coherent, rigid three-dimensional network of contiguous particles of colloidal silica). Gel-type silica is commercially available, for example under the trademark Sylojet™.

Fumed silica refers to silica prepared by a flame hydrolysis method. Fumed silica is commercially available, for example under the trademarks Cabosil™ and Aerosil™.

The total content of inorganic pigment particles in the composition is preferably from about 1 wt % to about 80 wt %, most preferably from about 5 wt % to about 70 wt %, particularly most preferably from about 10 wt % to about 60 wt % or from about 20 or even from about 25 to about 60 wt %.

The pigment composition preferably comprise a water soluble aluminium salt that preferably is present in an amount from about 0.1 wt % to about 10 wt % most preferably from about 0.2 wt % to about 5 wt %, calculated as wt % Al₂O₃ on dry pigment particles. Any aluminium containing salt may be used and examples of salts include aluminium chloride, poly aluminium chloride, poly aluminium silicate sulfate, aluminium sulfate, and mixtures thereof. The aluminium may be present partly or fully on the surface of the colloidal silica or silicate based particles and optional other pigment particles or in the aqueous phase.

The entire content of water soluble aluminium salt may originate from what is present in a cationic aluminium modified silica sol used for preparing the pigment composition. However, the pigment composition may also comprise additional aluminium salt.

The pigment composition preferably comprises a cationic organic polymer, preferably having an average molecular weight M_{w} from about 2000 to about 1000000, most preferably from about 2000 to about 500000, or from about 4000 to about 200000. The charge density is preferably from about 0.2 meq/g to about 12 meq/g, most preferably from about 0.3 meq/g to about 11 meq/g, or from about 0.5 meq/g to about 10 meq/g. The cationic organic polymer is preferably present in the pigment dispersion in an amount from about 0.1 wt % to about 20 wt %, more preferably from about 0.3 wt % to about 15 wt %, most preferably from about 0.4 wt % to about 10 wt %, based on the amount of dry pigment particles. Examples of suitable cationic organic polymers include synthetic and natural polyelectrolytes such as PAM (polyacrylamides), polyDADMAC (poly diallyl dimethyl ammoniumchloride), polyallyl amines, polyamines, polysaccharides and mixtures thereof, preferably fulfilling the above specifications in respect of molecular weight and charge density. The cationic polymer may be present partly or fully on the surface of the colloidal silica or silicate based particles and optional other pigment particles or in the aqueous phase.

Particularly preferred compositions comprise one or both of a water soluble aluminium salt as described above and a cationic polymer as described above.

The pigment composition may also comprise other additives commonly used for paper coating such as stabilisers, rheology modifiers, optical brighteners, lubricants, insolubilizers, dyes, sizing agents, binders etc, as well as various impurities from the raw materials. The total amount of other additives and possible impurities is preferably from 0 to about 50 wt %, most preferably from 0 to about 30 wt %, based on the dry content. The total dry content of the pigment composition is preferably from about 2 to about 80 wt %, most preferably from about 10 to about 75 wt % or from about 20 or even 30 to about 75 wt %.

A pigment composition as described above is preferably storage stable for at least one week, most preferably at least one month. The composition may be used directly for coating paper or paperboard or as an intermediate product for preparing a coating composition with further components.

It has been found that a composition comprising pigment particles of optionally aggregated primary silica or silicate based particles with a low surface area, preferably below 450 m²/g, and prepared from alkali metal silicate by ion exchange or pH-reduction as earlier described,

The invention further relates to a process for the production of a pigment composition as described above comprising mixing polyalkylene glycol and an aqueous composition comprising inorganic pigment particles comprising colloidal silica or silicate based particles in such amounts as to obtain a composition in which polyalkylene glycol constitutes from 50 to 100 wt %, preferably from 60 to 100 wt % or from 70 to 100 wt % of the total amount of organic material in the composition and the weight ratio of colloidal silica or silicate based particles to organic material in the composition is from 1:3 to 30:1, preferably from 1:1 to 20:1 or from 1.5:1 to 10:1. The polyalkylene glycol is preferably in substantially pure form and is preferably added to an aqueous dispersion of inorganic pigment particles, for example by dissolving a solid powder into the aqueous dispersion, but may also be diluted or dissolved into e.g. water beforehand.

A composition comprising a water soluble aluminium salt and/or a cationic organic polymer is preferably obtained by mixing these components with an aqueous dispersion, e.g. a sol, of colloidal silica or silicate based particles optionally also comprising other pigment particles as described herein and then adding polyalkylene glycol. Colloidal silica or silicate particles, water soluble aluminium salt and cationic polymer are preferably mixed in a way so substantial gelling or precipitation is avoided. For example, the aluminium salt and the cationic polymer may be mixed to form an aqueous solution thereof, and then an aqueous dispersion of colloidal and optionally other pigment particles can be added thereto, preferably under agitation to ensure that there always is a cationic net-charge of the particles in the resulting dispersion. Various suitable ways of mixing colloidal silica or silicate based particles and optionally other pigment particles with aluminium salts and cationic polymers are also described in the earlier mentioned WO 2006/049546 and WO 2006/049547.

Regarding suitable and preferred amounts and kinds of the components, the above description of the pigment composition is referred to.

An aspect of the invention concerns an aqueous pigment composition obtainable by a process as described above.

The invention also concerns the use of a pigment composition as described above for coating paper or paper board.

The invention further concerns a process for the production of coated paper or paperboard comprising a step of applying a pigment composition as described above as a coating to at least one side of a paper or paperboard web.

The coating is preferably applied in an amount sufficient to yield from about 0.4 g/m² to about 40 g/m², more preferably from about 0.5 g/m² to about 40 g/m², most preferably from about 1 g/m² to about 25 g/m² of inorganic pigment particles from the pigment composition per coated side of the paper or paper board web. In most cases the dry amount of coating applied per coated side of the paper or paper board is preferably from about 0.7 g/m² to about 50 g/m², most preferably from about 1.0 g/m² to about 30 g/m².

The coating is preferably applied to a non-coated side of the paper or paper board but may also be applied on top of a previously applied coating layer with the same or another coating composition. It is preferred not to apply any further coating of other kind on top of the layer formed from the coating as described herein.

Applying the coating can be performed either on the paper or board machine or off the paper or board machine. In either case any type of coating methods can be used. Examples of coating methods are blade coating, air knife coating, roll coating, curtain coating, spray coating, size press coating (e.g. film press coating) and cast coating. In case of metering film press coating, various rods and rod pressures could be used, for example from about 0.5 to about 8 bars or from about 1 to about 5 bars.

After applying the coating the paper is dried, which in the case of on machine coating preferably is accomplished in a drying section of the machine. Any means of drying may be used, such as infra red radiation, hot air, heated cylinders or any combination thereof. The paper may then undergo any kind of conventional treatment such as calendering and the like. Various calandering pressures can be used to achieve a desirable surface smoothness, for example from about 20 kN/m or lower up to about 700 kN/m or higher, or from about 50 or from about 100 to about 600 kN/m.

The term coating as used herein refers to any method in which pigments are applied to the surface of paper or paper board, thus including not only conventional coating but also other methods such as for example pigmenting.

The paper and paper board to be coated can be made from any kind of pulp, such as chemical pulp like sulfate, sulfite and organosolve pulps, mechanical pulp like thermo-mechanical pulp (TMP), chemo-thermo-mechanical pulp (CTMP), refiner pulp or ground wood pulp, from both hardwood and softwood bleached or unbleached pulp that is based on virgin or recycled fibres or any combination thereof. Paper and paper board from any other kind of pulp may also be coated in accordance with the invention. The paper and paper board may be internally sized to various degrees or non-sized and may contain commonly used fillers such as various kinds of clay, calcium carbonate, talc etc. The grammage may vary within a wide range, for example from about 40 to about 800 g/m² or higher, or from about 70 to about 300 g/m².

Regarding further details and embodiments of the pigment composition, the above description of the same is referred to.

The invention finally concerns coated paper or paper board obtainable by the process as described above and coated paper or paper board having on at least one side a coating comprising polyalkylene glycol and inorganic pigment particles comprising colloidal silica or silicate based particles or aggregates thereof, wherein polyalkylene glycol constitutes from 50 to 100%, preferably from 60 to 100 wt % or from 70 to 100 wt % of the total amount of organic material in the coating and the weight ratio of colloidal silica or silicate based particles or aggregates thereof to organic material in the composition is from 1:3 to 30:1, preferably from 1:1 to 20:1 or from 1.5:1 to 10:1.

Such paper or paper board preferably comprises a substantially transparent or substantially non-transparent layer comprising inorganic pigment particles from the coating composition, the pigment particles preferably forming a nano-structure. The dry amount of coating is preferably from about 0.5 g/m² to about 50 g/m², most preferably from about 1.0 g/m² to about 30 g/m². The amount of inorganic pigment particles from the above described pigment composition per coated side of the paper or paper board is preferably from about 0.7 g/m² to about 40 g/m², most preferably from about 1 g/m² to about 25 g/m². Preferably no other kind of coating has been applied on top of this layer.

It has been found that the paper or paper board of the invention is particularly suitable for ink jet printing, giving low line blurriness and mottling and high printing density for colours, but can advantageously also be used for other kinds of printing processes like toner, flexography, letter press, gravure, offset lithography and screen printing. The surface roughness, Parker Print Surf (PPS) may, for example, be from about 0.5 to about 10 μm or from about 1 to about 5 μm. It is a particular advantage that such good properties can be obtained in a simple manner by applying only small amounts of the coating and without the need to apply numerous different coating layers on the paper or paper board. Furthermore, the main components of the pigment composition can be made from readily available raw materials.

The invention will now be further described in following examples. Unless otherwise stated all parts and percentages refer to parts and percent by weight. Contents expressed as pph relate to parts per hundred parts of dry pigment particles.

### EXAMPLE 1

A pigment dispersion with a dry content of 43.9% was prepared from a mixture of a silica sol, Bindzil® 80/50 (anionic silica sol having a surface area of around 80 m²/g) from Eka Chemicals and a kaolin coating clay, SPS™ from Imerys Mineral. The dry weight ratio between silica sol and clay in the dispersion was 75/25. In order to cationise the pigments particles, 8.3 pph of poly aluminium chloride, (Locron™ L from Clariant) and 5.0 pph polyDADMAC, average molecular weight M_{w} of 4000, (40% polymer solution of Polyquat™ 40 U 05 NV from Katpol) were mixed together with the pigment blend. The resulting dispersion is hereinafter referred to as A.

Two coating formulations based on this pigment composition were prepared without adding any organic binder like starch, polyvinyl alcohol or latex.
B. The pigment dispersion A (see above) was diluted to 34 wt % dry content.
C. The pigment dispersion A was diluted with water and then 31 pph polyethylene glycol (PEG) with an average molecular weight M_{w} of 20000 from Merck was added to obtain a dry content of 35 wt %. The PEG was in the form of a 100% powder and was dissolved directly into the pigment dispersion.

The two coating formulations were applied on one side of the base paper with a continuous laboratory coater from DT Paper Science, Finland, run as a pond size press at a speed of 10 m/min. The base paper was a low sized fine paper with a width of 30 cm and basis weight of 85 g/m². After passing the size press the paper entered an infra red dryer followed by an air dryer. The coated paper was conditioned in 50% RH at 20° C. and the coat weight was determined. The paper was cut into A4 sized sheets and print tested on three different ink jet printers, Epson™ Stylos C86, HP™ deskjet 5850 and Canon™ ip4000.

The print results were evaluated using a print picture with seven colour blocs, cyan, magenta, yellow, green, red, blue and black. The printed blocs and the unprinted paper were measured with a spectrophotometer (Color Touch 2 from Technidyne) and the colour gamut volumes were calculated. The colour gamut volume is approximated with a dodecahedral in the CEI L*a*b* colour space and the measurements of the colours give the corners in the dodecahedral (see “Rydefalk Staffan, Wedin Michael; Litterature review on the colour Gamut in the Printing Process-Fundamentals, PTF-report no 32, May 1997”).

The results are shown in the table below, in which it can be seen that coating formulation C gave the best over-all colour gamut.

| | | Gamut | | |
|---|---|---|---|---|
| | Coat | volume | Gamut Volume | Gamut volume |
| Formulation | weight, g/m² | Epson | HP | Canon |
| Base Paper | 0 | 171528 | 172037 | 150500 |
| B | 5.3 | 201131 | 205269 | 178024 |
| C | 5.6 | 202731 | 217743 | 184420 |

### EXAMPLE 2

A trial was performed on a full-scale fourdrinier paper machine equipped with a pond size press, a machine normally producing high basis weight fine paper. During the trial 200 g/m² paper base paper was produced from 100% Hard Wood Kraft and precipitated calcium carbonate as filler with a machine speed of approximately 200 m/min. The base paper was surface treated on-line in the size press on both sides with a formulation as formulation C of Example 1 with the exception that the dry content was 34 wt %. The paper then entered drying cylinders and was finally slightly calendered on-line before it was rolled up. No runnability problems were encountered.

The paper produced was conditioned, printed and evaluated as described in Example 1 and the results are shown in the table below:

| | | | Gamute | |
|---|---|---|---|---|
| | Coat weight, | Gamute | volume | Gamut volume |
| Formulation | g/m²* | volume Epson* | HP* | Canon* |
| Base Paper | 0 | 177781 | 173917 | 154594 |
| C | 13 | 222864 | 222574 | 198195 |

*Average for both sides.

It could be noted that the coating formulation containing silica sol and PEG in this realistic, full-scale test gave very good print results and a significant up-grading of the base paper. It could also be noted that the coating formulations gave a high coating pick-up in the size press (high coat weight), meaning that a simple applicator such as a pond size press could be used for producing a “coated like” paper which is normally only possible with more sophisticate applicators, such as blade coaters.

### EXAMPLE 3

In this test five different coating formulations were prepared with the target to produce maximum dry content for each formulation (for runnability reason, meaning that the viscosity of the formulation should be between 100-1000 cP as measured with a Brookfield viscosity meter (No 4 spindle at 50 rpm)).
D. A formulation was prepared by adding 24 g dry PEG (same as in Example 1) into 176 g of pigment dispersion A of Example 1 under magnetic stirring, giving a final formulation with a dry content of 50.6 wt %, a viscosity of 860 cP and containing 34 pph PEG based on dry pigment particles.
E. 8.2 g dry PEG (same as in Example 1) was directly dissolved in the 119 g of pigment dispersion A of Example 1 and then 82 g of a 10 wt % aqueous polyvinyl alcohol (PVOH) solution was added under magnetic stirring. The PVOH solution was prepared by dissolving powder of PVOH (Ercol™ 26-88, from Ercol, a type of product commonly used as binder in production of inkjet paper) into hot water at 90° C. during 2 hours. The maximum PVOH concentration possible to obtain was 10 wt %. The dry content of the final formulation became 32.8 wt %, the viscosity 244 cP, the content of PEG 17 pph and a content of PVOH 17 pph.
F. 164 g of a 10 wt % PVOH solution (same as in E) was slowly added to 119 g of pigment dispersion A of Example 1 under magnetic stirring. The dry content of the final formulation became 24.3 wt %, the viscosity 516 cP and a content of PVOH 34 pph.
G. A 20 wt % aqueous solution of a typical size press starch was prepared by cooking starch granules (C* film 07312 from Cerestar) in water. 20 wt % was the maximum concentration that could be obtained. 119 g pigment dispersion A of Example 1 was mixed with 82.2 g starch solution, giving a final formulation with a dry content of 34.1 wt % and a viscosity of more than 1000 cP.
H. 60 g of a dry powder gel type silica, Sylojet™ P612 from Grace Davison, was dispersed in 150.7 g water, resulting in a high viscous dispersion. 20.4 g (34 pph) of PEG (same as in Example 1) and 3 g (5 pph) polyDADMAC (same as in Example 1) were directly dissolved into the pigment dispersion, giving a final formulation having a dry content of 34.9 wt %, and a viscosity of 300 cP.

The five formulations were applied with the continuous laboratory coater as in Example 1 (same base paper, applicator, speed etc.). The surface treated papers were conditioned, printed and evaluated as described in example 1. The results are shown in the table below:

| | | | Gamut | |
|---|---|---|---|---|
| | Coat weight, | Gamut volume | volume | Gamut volume |
| Formulation | g/m² | Epson | HP | Canon |
| Base Paper | 0 | 171528 | 172037 | 150500 |
| D | 11 | 227492 | 235453 | 212530 |
| E | 5 | 197735 | 214238 | 174423 |
| F | 7 | 202034 | 203175 | 166695 |
| G | 7 | 215063 | 192036 | 160857 |
| H | The pigments | — | — | — |
| | did not adhere | | | |
| | to the base | | | |
| | paper | | | |

It appears that Formulation D comprising silica sol and PEG made it possible to apply high amounts of pigment particles in a single coating operation and also gave the highest colour gamut. When PEG was partly (E) or fully (F and G) replaced by the water soluble binders, PVOH or starch, the colour gamut is significantly reduced. In test H where a precipitated silica was used together with PEG the pigment was extremely poorly bonded to the paper, indicating that this kind of pigment would require addition of a binder.

### EXAMPLE 4

Two silica sols from Eka Chemicals AB, Bindzil® 40/220 (an anionic silica sol with a dry weight concentration of 40 wt % and a surface area of 220 m²/g) and Bindzil® CAT 220 (Bindzil CAT 220 is a cationic silica sol with a dry weight concentration of 35 wt % and a surface area of 220 m²/g), were used in these tests.
I. 175 g Bindzil 40/220 was diluted with 25 g water to reach a dry content of 35 wt %.
J. 175 g Bindzil 40/220 was diluted with 54.9 g water. 16.1 g dry powder of 100% PEG (M_{w} 35000) from Merck was dissolved into the silica sol, resulting in a formulation having a dry content of 35 wt % and containing 23 pph PEG.
K. 200 g Bindzil CAT 220 was diluted with 10.2 g water. 14.7 g PEG (as in J) was dissolved into the sol, resulting in a formulation having a dry content of 38 wt % and containing 23 pph PEG.

These three formulations were applied on base paper and tested as in Example 1. The results are shown in the table below:

| | | | Gamut | |
|---|---|---|---|---|
| | Coat weight, | Gamut volume | volume | Gamut volume |
| Formulation | g/m² | Epson | HP | Canon |
| Base Paper | 0 | 171528 | 172037 | 150500 |
| I | 13 | 120544 | 184116 | 156466 |
| J | 13 | 166290 | 201414 | 166555 |
| K | 11 | 238878 | 222453 | 189849 |

It appears that the combination of silica sol and PEG gave the best over all print results.

1. An aqueous pigment composition comprising polyalkylene glycol and inorganic pigment particles comprising colloidal silica or silicate based particles or aggregates thereof, wherein polyalkylene glycol constitutes from 50 to 100 wt % of the total amount of organic material in the composition and the weight ratio of colloidal silica or silicate based particles or aggregates thereof to organic material in the composition is from 1:3 to 30:1.

2. The pigment composition as claimed in claim 1, wherein the amount of polyalkylene glycol in the composition is from about 1 to about 50 wt %.

3. The pigment composition as claimed in claim 1, wherein said polyalkylene glycol is polyethylene glycol.

4. The pigment composition as claimed in claim 1, wherein said polyalkylene glycol has an average molecular weight M_{w} from about 1000 to about 100000.

5. The pigment composition as claimed in claim 1, wherein the composition comprises, as a source of pigment particles, an aqueous sol of colloidal, optionally aggregated, silica or silicate based primary particles.

6. The pigment composition as claimed in claim 5, wherein the colloidal primary particles in the sol are formed from an aqueous solution of alkali metal silicate where alkali metal ions have been removed through an ion exchange process or where the pH of the alkali metal silicate solution has been reduced by the addition of an acid.

7. (canceled)

8. (canceled)

9. The pigment composition as claimed in claim 1, wherein the colloidal particles comprise silicate based particles which comprise aluminosilicate or borosilicate.

10. The pigment composition as claimed in claim 1, wherein the colloidal silica or silicate based particles or aggregates thereof have a surface area from about 30 to about 450 m²/g.

11. The pigment composition as claimed in claim 1, wherein the colloidal silica or silicate based particles have a mean diameter from about 0.005 μm to about 25 μm.

12. The pigment composition as claimed in claim 1, wherein said pigment particles comprise particles of at least one of kaolinites, smectites, talcites, calcium carbonate minerals, precipitated calcium carbonate, and mixtures thereof.

13. The pigment composition as claimed in claim 1, further comprising at least one water soluble aluminium salt.

14. The pigment composition as claimed in claim 13, wherein said at least one water soluble aluminium salt is at least one of aluminium chloride, poly aluminium chloride, poly aluminium silicate sulfate, aluminium sulfate, and mixtures thereof.

15. The pigment composition as claimed in claim 1, further comprising at least one cationic polymer.

16. The pigment composition as claimed in claim 15, wherein said cationic polymer has a molecular weight M_{w} from about 2000 to about 1000000 and a charge density from about 0.2 to about 12 meq/g.

17. The pigment composition as claimed in claim 15, wherein said at least one cationic polymer is at least one of PAM (polyacrylamides), polyDADMAC (poly diallyl dimethyl ammoniumchloride), polyallyl amines, polyamines, polysaccharides and mixtures thereof.

18. (canceled)

19. (canceled)

20. (canceled)

21. (canceled)

22. (canceled)

23. A process for the production of coated paper or paperboard comprising a step of applying an aqueous pigment composition comprising polyalkylene glycol and inorganic pigment particles comprising colloidal silica or silicate based particles or aggregates thereof, wherein polyalkylene glycol constitutes from 50 to 100 wt % of the total amount of organic material in the composition and the weight ratio of colloidal silica or silicate based particles or aggregates thereof to organic material in the composition is from 1:3 to 30:1 to at least one side of a paper or paperboard web.

24. The process as claimed in claim 23, wherein the coating is applied in an amount sufficient to yield from about 0.4 g/m² to about 40 g/m² of inorganic pigment particles from the pigment composition per coated side of the paper or paper board.

25. A coated paper or paper board having on at least one side a coating comprising polyalkylene glycol and inorganic pigment particles comprising colloidal silica or silicate based particles or aggregates thereof, wherein polyalkylene glycol constitutes from 50 to 100% of the total amount of organic material in the coating and the weight ratio of colloidal silica or silicate based particles or aggregates thereof to organic material in the coating is from 1:3 to 30:1.

26. (canceled)
